(19) United States
(12) Patent Application Publication
(10) Pub. No.: US 2012/0144439 A1
(43) Pub. Date: Jun. 7, 2012

(54) METHOD AND SYSTEM FOR PLAYING ORDER PROGRAM AND SERVER ENDPOINT FOR SENDING ORDER PROGRAM

(75) Inventor: Xu-Peng Yang, Nanchang City (CN)

(73) Assignee: SHENZHEN COSHIP ELECTRONICS CO., LTD., Shenzhen, Guangdong (CN)

(21) Appl. No.: 13/144,087

(22) PCT Filed: Dec. 30, 2009
(86) PCT No.: PCT/CN2009/076258

§ 371 Date: Feb. 20, 2012

(30) Foreign Application Priority Data
Jan. 14, 2009 (CN) 200910105043.5

(51) Int. Cl. H04N 21/20

(52) U.S. Cl. 725/93

(57) ABSTRACT

For playing an order program in the present invention, an order program request signal is sent from a digital television receiving terminal. Then linkage program request information is generated and parsed according to the order program request signal. Search the preset recording list according to user identification information to locate a program breakpoint time, wherein the recording list is used for storing and correlating user identification information to program breakpoint time. The located program breakpoint time is set as a playback start time specified in the parsed linkage program request information, and then the linkage program request information is reformed. The digital television receiving terminal is controlled to play the order program from the playback start time specified in the reformed linkage program request information, thereby accomplishing breakpoint resuming of the order program so as to allow a user to watch the order program as desired.

### CROSS REFERENCE TO RELATED APPLICATIONS

The present application claims priority from a Chinese patent application bearing an application number 200910105043.5, entitled “METHOD AND SYSTEM FOR PLAYING ORDER PROGRAM AND SERVER ENDPOINT FOR SENDING ORDER PROGRAM” and filed Jan. 14, 2009, all the contents of which are incorporated herein for reference.

### TECHNICAL FIELD

The present invention relates to a technical field of audio/video frequency point order, and more particularly to method and system for playing an order program and a server endpoint for sending an order program.

### BACKGROUND

Interactive television (ITV) system provides a new type of information service, which enhances the interactive capability of a common television set. A user may, on personal demands, acquire a variety of network services including video service, digital library service, multimedia information service, etc. However, current interactive TV systems commonly play order programs in respective frequency points following time divisions. Thus, when ordering programs, the user can only choose a recent program from the programs among the time divisions, which is been playing right now. If the user stops watching the program on playing, selection is required to be made for ordering the program again. Therefore, the applicability of the prior art method for playing an order program is poor.

### SUMMARY OF EMBODIMENTS

An objective of the embodiments according to the present invention is to provide a method for playing an order program so as to solve the poor applicability problem encountered by the prior art interactive television system which play order programs in respective frequency points following time divisions so that if the user stops watching the program on playing, selection is required to be made for ordering the program again.

The embodiments according to the present invention are implemented by a method for playing an order program, comprising steps of: receiving an order program request signal sent from a digital television receiving terminal; generating linkage program request information and parsing the linkage program request information according to the order program request signal; searching a preset recording list according to user identification information included in the parsed linkage program request information to locate a program breakpoint time; setting the located program breakpoint time as a playback start time specified in the parsed linkage program request information, and then reforming the linkage program request information; and controlling the digital television receiving terminal to play the order program from the playback start time specified in the reformed linkage program request information.

Another objective of the embodiments according to the present invention is to provide a server endpoint for sending an order program, characterized in comprising: a storing unit for storing a recording list, which correlates and reveals user identification information and program endpoint time; a linkage-program-request-information generating unit for receiving an order program request signal from a digital television receiving terminal, and generating linkage program request information according to the received order program request signal inputted by a client; a linkage-program-request-information parsing unit for parsing the linkage program request information generated by the linkage-program-request-information generating unit; a searching unit for searching the recording list stored in the storing unit according to the user identification information included in the linkage program request information parsed by the linkage-program-request-information parsing unit to locate a program breakpoint time; setting unit for setting the located program breakpoint time as a playback start time specified in the linkage program request information parsed by the linkage-program-request-information parsing unit; a linkage-program-request-information reforming unit for reforming the linkage program request information; and a program displaying control unit for controlling the digital television receiving terminal to play the order program from the playback start time specified in the reformed linkage program request information.

A further objective of the embodiments according to the present invention is to provide a system for playing an order program, comprising a digital television receiving terminal and a server endpoint coupled to the digital television receiving terminal for sending the order program as described above.

In the embodiments according to the present invention, by way of parsing the linkage program request information to realize the user identification information and the playback start time, searching the program breakpoint time stored in the recording list to set the program breakpoint time to be the playback start time, reforming the linkage program request information, and controlling the digital television receiving terminal to play the order program from the playback start time specified in the reformed linkage program request information, breakpoint resuming of the order program can be accomplished so as to allow a user to watch the order program as desired.

### BRIEF DESCRIPTION OF THE DRAWINGS

FIG. 1 is a flowchart of a method for playing an order program provided by an embodiment according to the present invention; and

FIG. 2 is a scheme illustrating the principle of a server endpoint for sending the order program provided by an embodiment according to the present invention.

### DETAILED DESCRIPTION OF PREFERRED EMBODIMENTS

For illustrating the objectives, technical means and advantages of the present invention in a clearer way, the present invention is described with reference to the drawings and embodiments. It is to be understood that the embodiments are used for illustrating the present invention rather than limiting the present invention.

In the embodiments according to the present invention, linkage program request information is parsed to realize user identification information and playback start time; program breakpoint time stored in the recording list is located; the linkage program request information is reformed after the program breakpoint time is set to be playback start time; and the digital television receiving terminal is controlled to play the order program from the playback start time specified in the reformed linkage program request information.

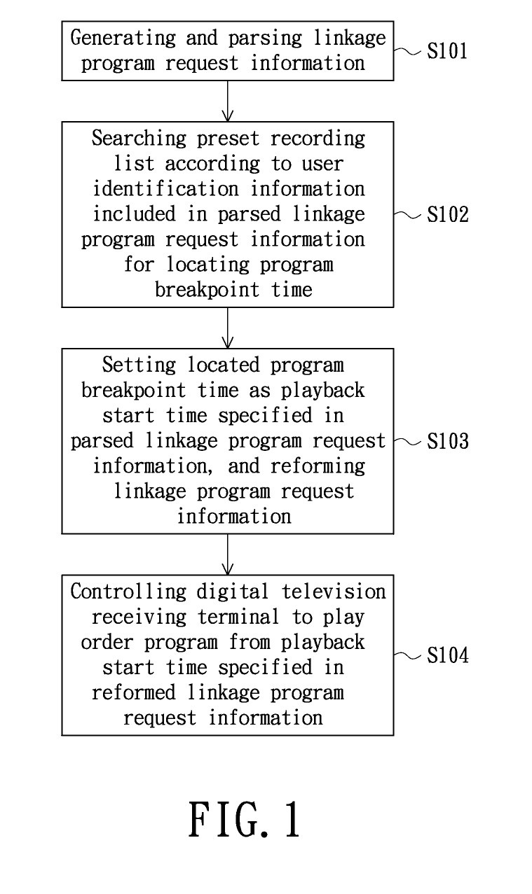

FIG. 1 shows a flowchart of a method for playing an order program provided by an embodiment according to the present invention. In the embodiment, the following is included:

In Step S101, linkage program request information are generated and then parsed.

According to an embodiment of the present invention, Step S101 is implemented by receiving an order program request signal sent from a digital television receiving terminal and generating the linkage program request information according to the order program request signal, wherein the linkage program request information may include user identification information (such as the name of the end user) and requested order program information (such as title and type of the requested program).

Before the step of receiving an order program request signal sent from a digital television receiving terminal, the following steps may be included: receiving verifying information, e.g. name of the client, password of the client and terminal type label, from the digital television receiving terminal being powered on; and discriminating whether the user is a valid client according to the verifying information, and calling and sending an order interface with order program linkage prompts to the digital television receiving terminal if the user is a valid client, wherein the order interface is previously stored and corresponds to the terminal type label specified in the verifying information. Otherwise, return the digital television receiving terminal to prompt a message of verifying again.

In Step 102, a preset recording list is searched according to user identification information included in the parsed linkage program request information for locating a program breakpoint time.

According to an embodiment of the present invention, a step of previously storing the recording list with the user identification information and the program breakpoint time before Step S102 is performed, which may be implemented by setting a preceding playback endpoint time of the order program as the program breakpoint time of the order program, and correlating and storing the program endpoint time and the user identification information of the client.

In Step 103, the located program breakpoint time is set as a playback start time specified in the parsed linkage program request information, and then the linkage program request information is reformed.

If there is no program breakpoint time found and located, it means that the client requests for watching the program at the first time, and the playback start time is set to be null.

In Step 104, the digital television receiving terminal is controlled to play the order program from the playback start time specified in the reformed linkage program request information.

According to an embodiment of the present invention, the above step is implemented by parsing out the user identification information, title and type of the requested program and the playback start time from the reformed linkage program request information; and sending the order program conforming to the title and type of the requested program to the digital television receiving terminal corresponding to the user identification information so as to have the digital television receiving terminal start playing the program from the playback start time.

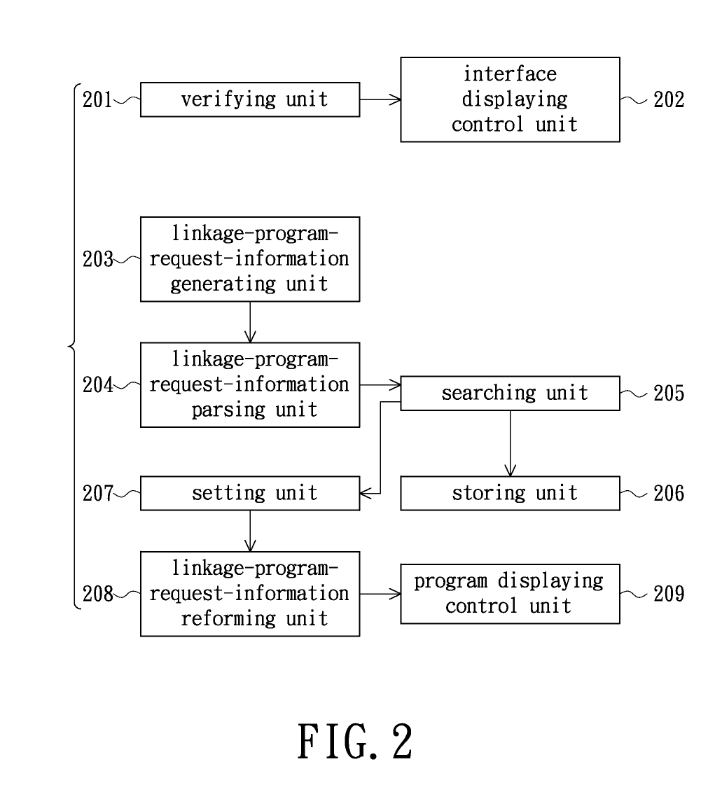

FIG. 2 is a scheme illustrating the principle of a server endpoint for sending the order program provided by an embodiment according to the present invention. For easy illustration, only parts associated with the embodiments of the present invention are shown.

A verifying unit 201 receives verifying information from the digital television receiving terminal being powered on, including name of the client, password of the client and terminal type label, etc., and discriminates whether the user is a valid client according to the verifying information. If positive, it will send a signal to an interface displaying control unit 202, which calls and sends an order interface with order program linkage prompts to the digital television receiving terminal. On the contrary, when the verifying unit 201 determines that the user is not a valid client according to the verifying information, it issues a message of returning the digital television receiving terminal to the prompt and performing verification again.

A linkage-program-request-information generating unit 203 receives an order program request signal from the digital television receiving terminal, generates linkage program request information according to the signal, and sends the linkage program request information to a linkage-program-request-information parsing unit 204, wherein the linkage program request information includes user identification information (such as the name of the end user) and requested order program information (such as title and type of the requested program). The linkage-program-request-information parsing unit 204 receives and parses the linkage program request information. A searching unit 205 searches the recording list stored in a storing unit 206 according to the user identification information included in the linkage program request information parsed by the linkage-program-request-information parsing unit 204 to locate a program breakpoint time, and sends the program breakpoint time a setting unit 207. According to an embodiment of the present invention, the storing unit 206 is used for storing a preceding playback endpoint time of the order program set as the program breakpoint time of the order program for a specified client, and correlating and storing the program endpoint time and the user identification information of the specified client.

The setting unit 207 sets the program breakpoint time located by the searching unit 205 as a playback start time specified in the linkage program request information parsed by the linkage-program-request-information parsing unit 204. A linkage-program-request-information reforming unit 208 reforms and sends out the linkage program request information. A program displaying control unit 209 receives and parses the reformed linkage program request information to acquire user identification information, title and type of the requested program and playback start time, and sends the order program conforming to the title and type of the requested program to the digital television receiving terminal corresponding to the user identification information so as to have the digital television receiving terminal play the program from the corresponding playback start time.

An embodiment of the present invention further provides a system for playing an order program, comprising a digital television receiving terminal and a server endpoint coupled to the digital television receiving terminal for sending the order program as described above. The server endpoint for sending the order program may be a hardware unit, software unit or combined hardware/software unit built in the system for playing an order program.

In the embodiments according to the present invention, by way of parsing the linkage program request information to realize the user identification information and the playback start time, searching the program breakpoint time stored in the recording list to set the program breakpoint time to be the playback start time, reforming the linkage program request information, and controlling the digital television receiving terminal to play the order program from the playback start time specified in the reformed linkage program request information, breakpoint resuming of the order program can be accomplished so as to allow a user to watch the order program as desired. Since the recorded program breakpoint time correlates to the user identification information, a user may watch a program in a relay way on different terminals.

It is understood by those ordinary in the art that all or parts of the steps of the method for playing an order program can be implemented by controlling associated hardware by way of programs. The programs may be stored in an accessible storage medium of a computer, and the storage medium, for example, can be ROM/RAM, a magnetic disc, or an optical disc.

What is described above is preferred embodiments according to the present invention only rather than used for limiting the present invention. On the contrary, it is intended to cover various modifications and similar arrangements included within the spirit and scope of the appended claims which are to be accorded with the broadest interpretation so as to encompass all such modifications and similar structures.

1. A method for playing an order program, comprising steps of:
receiving an order program request signal sent from a digital television receiving terminal;
generating linkage program request information and parsing the linkage program request information according to the order program request signal;
searching a preset recording list according to user identification information included in the parsed linkage program request information to locate a program breakpoint time, wherein the recording list stores and correlates the user identification information and the program breakpoint time;
setting the located program breakpoint time as a playback start time specified in the parsed linkage program request information, and then reforming the linkage program request information; and
controlling the digital television receiving terminal to play the order program from the playback start time specified in the reformed linkage program request information.

2. The method for playing an order program according to claim 1, before the step of receiving an order program request signal sent from a digital television receiving terminal, further comprising:
receiving verifying information from the digital television receiving terminal being powered on; and
discriminating whether the user associated with the digital television receiving terminal is a valid client according to the verifying information, and calling and sending an order interface with order program linkage prompts to the digital television receiving terminal if the user is a valid client, wherein the order interface is previously stored and corresponds to a type label of the digital television receiving terminal specified in the verifying information.

3. The method for playing an order program according to claim 1, wherein the preset recording list is established by:
setting a preceding playback endpoint time of the order program as the program breakpoint time of the order program for a specified client, and storing and correlating the program endpoint time and the user identification information of the specified client into the preset recording list.

4. The method for playing an order program according to claim 1, wherein the step of controlling the digital television receiving terminal to play the order program from the playback start time specified in the reformed linkage program request information is implemented by:
parsing out the user identification information, title and type of the requested program and the playback start time from the reformed linkage program request information; and
sending the order program conforming to the title and type of the requested program to the digital television receiving terminal corresponding to the user identification information, starting from the corresponding playback start time.

5. The method for playing an order program according to claim 1, wherein if no program breakpoint time is located in the preset recording list according to the user identification information included in the parsed linkage program request information, the step of setting the located program breakpoint time as the playback start time specified in the parsed linkage program request information is replaced by setting the playback start time specified in the parsed linkage program request information to be null.

6. A server endpoint for sending an order program, comprising:
a storing unit for storing a recording list, which correlates and reveals user identification information and program endpoint time;
a linkage-program-request-information generating unit for receiving an order program request signal from a digital television receiving terminal, and generating linkage program request information according to the received order program request signal inputted by a client;
a linkage-program-request-information parsing unit for parsing the linkage program request information generated by the linkage-program-request-information generating unit;
a searching unit for searching the recording list stored in the storing unit according to the user identification information included in the linkage program request information parsed by the linkage-program-request-information parsing unit to locate a program breakpoint time;
a setting unit for setting the located program breakpoint time as a playback start time specified in the linkage program request information parsed by the linkage-program-request-information parsing unit;
a linkage-program-request-information reforming unit for reforming the linkage program request information; and
a program displaying control unit for controlling the digital television receiving terminal to play the order program from the playback start time specified in the reformed linkage program request information.

7. The server endpoint for sending an order program according to claim 6, further comprising:
a verifying unit for receiving verifying information from the digital television receiving terminal being powered on, and discriminating whether the user associated with the digital television receiving terminal is a valid client according to the verifying information; and
an interface displaying control unit for calling and sending an order interface with order program linkage prompts to the digital television receiving terminal when the discriminating result of the verifying unit shows that the user is a valid client, wherein the order interface is previously stored and corresponds to a type label of the digital television receiving terminal specified in the verifying information.

8. The server endpoint for sending an order program according to claim 6, wherein the storing unit further sets a preceding playback endpoint time of the order program as the program breakpoint time of the order program for a specified client, and correlating and storing the program endpoint time and the user identification information of the specified client into the recording list.

9. The server endpoint for sending an order program according to claim 6, wherein the setting unit sets the playback start time specified in the parsed linkage program request information to be null if the searing unit locates no program breakpoint time.

10. A system for playing an order program, comprising a digital television receiving terminal and a server endpoint for sending an order program as recited in claim 6.
